(19) United States
(12) Patent Application Publication
(10) Pub. No.: US 2004/0111510 A1
(43) Pub. Date: Jun. 10, 2004

(54) Method of dynamically switching message logging schemes to improve system performance

(76) Inventors: Shahid Shoaib, San Jose, CA (US); Nayeem Islam, Palo Alto, CA (US); Masaji Katagiri, Los Altos, CA (US)

Correspondence Address: Brinks Hofer Gilson & Lione, NBC Tower, NBC Tower, Suite 3600, P.O. Box 10395, Chicago, IL, 60610, US

(21) Appl. No.: 10/430,448

(22) Filed: May 6, 2003

Related U.S. Application Data
(60) Provisional application No. 60/431,515, filed on Dec. 6, 2002.
(60) Provisional application No. 60/435,056, filed on Dec. 18, 2002.

(51) Int. Cl. G06F 15/173

(52) U.S. Cl. 709/224

(57) ABSTRACT

In one aspect of the invention, a method of dynamically switching message logging schemes to improve performance of a distributed system is provided. The distributed system includes a client device and a server device that communicate by sending and receiving messages across a network. The method includes measuring a system load for the server and a network delay for the messages transmitted between the client and the server. The method further includes selecting at least one of a client-side message logging scheme and a server-side message logging scheme based on a determination of whether the system load is greater than a system load threshold and whether the network delay is greater than a network delay threshold.

### RELATED APPLICATION

This application is related to application Ser. No. 10/243,083, Attorney Docket No. 10745/133, filed Sep. 13, 2002, entitled “Method For Dynamically Switching Fault Tolerance Schemes,” naming as inventors Shahid Shoaib and Nayeem Islam and application Ser. No. 10/313,265, Attorney Docket No. 10745/134, filed Dec. 6, 2002, entitled “Configurable Reliable Messaging System,” naming as inventors Shahid Shoaib and Nayeem Islam.

This application claims the benefit pursuant to 35 U.S.C. §119(e) of Provisional U.S. Patent Application Serial No. 60/431,515 filed on Dec. 6, 2002, which is expressly incorporated herein by reference, and Provisional U.S. Patent Application Serial No. 60/435,056 filed on Dec. 18, 2002, which is expressly incorporated herein by reference.

### BACKGROUND OF THE INVENTION

The present invention relates generally to fault tolerant computing systems, and in particular, to a method of dynamically switching message logging schemes in a fault tolerant computing system based on a measure of application response time, system load and network delay to improve system performance.

Fault tolerance is a key technology in distributed systems for ensuring reliability of operations for user critical applications, such as e-commerce, database transactions and business-to-business (B2B) applications. A distributed system is a group of computing devices interconnected with a communication network which function together to implement an application. For example, the Internet is a global network of networks that connects computers globally for performing a large set of activities, ranging from personal activities such as e-commerce, stock trading and online auctions to intra-business activities such as B2B transactions. Fault tolerance provides reliability of operation for a distributed system from the user's perspective by masking failures in critical system components, including application processes, devices and communication mechanisms.

With the advent of the mobile Internet, applications that are typically short running, data driven, interactive and request/response in nature will be used in mobile devices to access web services from remote web servers. Web services use the HTTP protocol to allow applications to share information over the Internet. Users will expect at least the same or even greater amount of reliability from web services on mobile devices as from web services targeted for PC or desktop computing environments.

Messaging is a popular communication mechanism for applications that need to access reliable web services because messages can be delivered according to application specified delivery semantics, such as at most once, at least once and exactly once. Fault tolerant communication for mobile Internet applications that communicate via message passing can be realized through message logging. Message logging is a fault tolerance mechanism for preserving the communications state of an application by logging messages during failure free operation. Applications can use logged messages to recover their communication state in case of a device or network failure.

Different message logging schemes may be implemented in a particular system depending on the types and extent of failures to be tolerated. However, there is a trade-off between fault tolerance and system performance because each message logging scheme incurs some overhead during failure free operation, which can degrade system performance. In addition, changes in the system can alter the trade-off between fault tolerance and system performance for any given message logging scheme. For example, network conditions may vary, a mobile device may run out of battery power or the load at a web server that provides web services to mobile clients may increase.

In this context, it is important to preserve the communications state of an application by providing optimized message logging during failure free operation. Therefore, there is a need for a method of determining when to switch message logging schemes and which scheme to select in order to provide more effective fault tolerance with improved system performance.

### SUMMARY

In one aspect of the invention, a method of dynamically switching message logging schemes to improve performance of a distributed system is provided. The distributed system includes a client device and a server device that communicate by sending and receiving messages across a network. The client device is capable of executing a client-side message logging scheme and the server device is capable of executing a server-side message logging scheme. The method includes measuring an application response time for an application that executes using the client device and the server device, measuring a system load for the server device and measuring a network delay for the messages. In addition, the method includes selecting the client-side message logging scheme when the application response time is greater than an application response time threshold and the system load is greater than a system load threshold and the network delay is less than a network delay threshold. The method also includes selecting both the client-side message logging scheme and the server-side message logging scheme when the application response time is greater than the application response time threshold and the system load is less than the system load threshold and the network delay is greater than the network delay threshold. The method further includes selecting at least one of the client-side message logging scheme and the server-side message logging scheme when the application response time is greater than the application response time threshold and the system load is less than the system load threshold and the network delay is less than the network delay threshold. The method also includes selecting both the client-side message logging scheme and the server-side message logging scheme when the application response time is greater than the application response time threshold and the system load is greater than the system load threshold and the network delay is greater than the network delay threshold.

In another aspect of the invention, a computer program product embodied on a computer usable medium for dynamically switching message logging schemes to improve performance of the distributed system is provided. The computer program product includes instructions for measuring an application response time for an application that executes using the client device and the server device, instructions for measuring a system load for the server device and instructions for measuring a network delay for the messages. In addition, the computer program product includes instructions for selecting the client-side message logging scheme when the application response time is greater than an application response time threshold and the system load is greater than a system load threshold and the network delay is less than a network delay threshold. The computer program product also includes instructions for selecting both the client-side message logging scheme and the server-side message logging scheme when the application response time is greater than the application response time threshold and the system load is less than the system load threshold and the network delay is greater than the network delay threshold. The computer program product further includes instructions for selecting at least one of the client-side message logging scheme and the server-side message logging scheme when the application response time is greater than the application response time threshold and the system load is less than the system load threshold and the network delay is less than the network delay threshold. The computer program product also includes instructions for selecting both the client-side message logging scheme and the server-side message logging scheme when the application response time is greater than the application response time threshold and the system load is greater than the system load threshold and the network delay is greater than the network delay threshold.

In yet another aspect of the invention, a method of dynamically switching message logging schemes to improve performance of the distributed system is provided. The method includes measuring a system load for the server and measuring a network delay for the messages. The method further includes selecting at least one of a client-side message logging scheme and a server-side message logging scheme based on whether the system load is greater than a system load threshold and whether the network delay is greater than a network delay threshold.

In yet another aspect of the invention, a server device for dynamically switching message logging schemes to improve system performance is provided. The server device is capable of communicating with a client device by sending and receiving messages across a network. At least one of the server device and the client device is capable of logging the messages. The server device includes a processor for executing program instructions and a memory connected with the processor for storing the programs instructions. The program instructions include a first set of instructions for measuring a system load for the server and a second set of instructions for measuring a network delay for the messages. The program instructions further include a third set of instructions for selecting at least one of a client-side message logging scheme and a server-side message logging scheme based on whether the system load is greater than a system load threshold and whether the network delay is greater than a network delay threshold.

In yet another aspect of the invention, a method of dynamically switching message logging schemes to improve performance of the distributed system is provided. The method includes measuring a system load for the server device and measuring a network delay for the messages. In addition, the method includes selecting the client-side message logging scheme when the system load is greater than a system load threshold and the network delay is less than a network delay threshold. The method also includes maintaining a current message logging scheme when the system load is less than the system load threshold and the network delay is greater than the network delay threshold. The method further includes selecting at least one of the client-side message logging scheme and the server-side message logging scheme when the system load is less than the system load threshold and the network delay is less than the network delay threshold. The method also includes selecting the client-side message logging scheme when the system load is greater than the system load threshold and the network delay is greater than the network delay threshold.

In another aspect of the invention, a computer program product embodied on a computer usable medium for dynamically switching message logging schemes to improve performance of the distributed system is provided. The computer program product includes instructions for measuring a system load for the server device and measuring a network delay for the messages. In addition, the computer program product includes instructions for selecting the client-side message logging scheme when the system load is greater than a system load threshold and the network delay is less than a network delay threshold. The computer program product also includes instructions for maintaining a current message logging scheme when the system load is less than the system load threshold and the network delay is greater than the network delay threshold. The computer program product further includes instructions for selecting at least one of the client-side message logging scheme and the server-side message logging scheme when the system load is less than the system load threshold and the network delay is less than the network delay threshold. The computer program product also includes instructions for selecting the client-side message logging scheme when the system load is greater than the system load threshold and the network delay is greater than the network delay threshold.

### BRIEF DESCRIPTION OF THE DRAWINGS

FIG. 1 is a block diagram of a typical distributed system for implementing a method of dynamically switching message logging schemes according to the present invention;

FIG. 2 is a block diagram showing a timeline of a user interaction in the distributed system of FIG. 1;

FIG. 3 is a decision tree for a method of dynamically switching message logging schemes to optimize application response times according to the present invention; and

FIG. 4 is a decision tree for another method of dynamically switching message logging schemes to optimize server transaction rates according to the present invention.

### DETAILED DESCRIPTION OF THE DISCLOSED EMBODIMENTS

Reference will now be made in detail to an implementation of the present invention as illustrated in the accompanying drawings. The disclosed embodiments of the present invention are illustrated in the context of a reliable messaging system, which is a dynamically reconfigurable fault tolerant message-based communication mechanism. It will be recognized, however, that the principles disclosed herein may be applied to a wide variety of systems and devices.

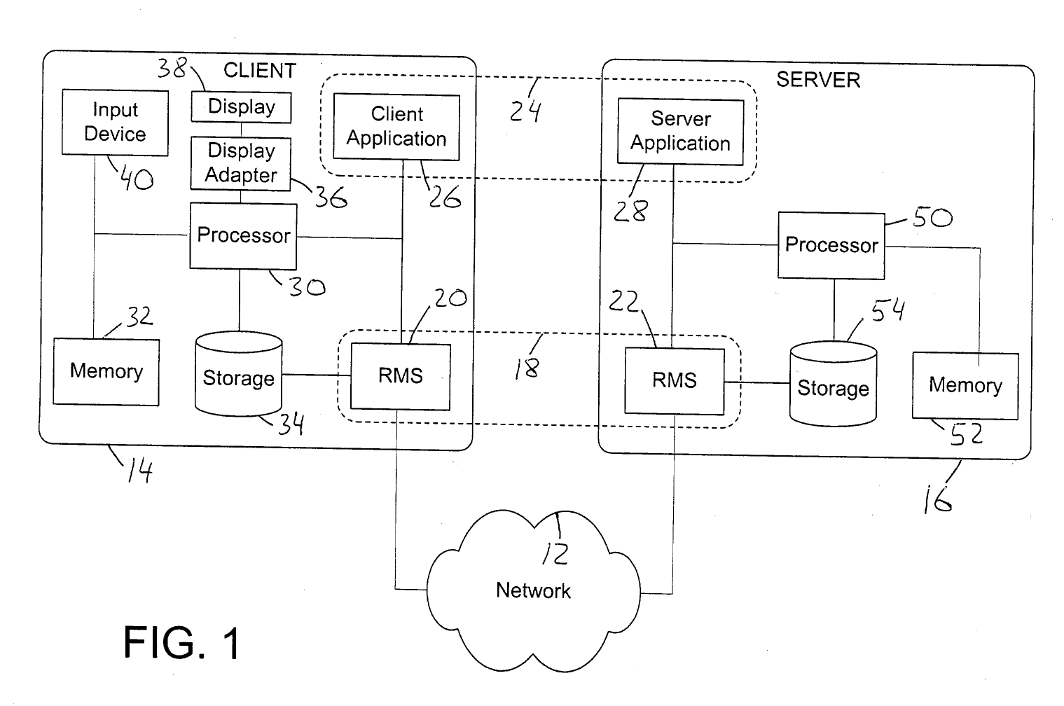

Referring to FIG. 1, there is shown a representative reliable messaging system 18 in a typical distributed system 10 having a client/server architecture. Those skilled in the art will recognize that a client/server architecture is not the only vehicle for implementing the present invention, and the present invention may be implemented in a distributed system based on other types of network architectures, such as a peer-to-peer architecture.

The distributed system 10 includes a network 12 connected to a client device 14 and a server device 16 that together execute a client/server application 24. The network 12 may be, for example, a wired local access network (“LAN”), an IEEE standard 802.11b (Wi-Fi) wireless LAN, a Bluetooth network, a cellular network or General Packet Radio Service (GPRS) mobile telephone network. The client device 14 may be, for example, a desktop personal computer (“PC”), a portable computer (“laptop”), a personal digital assistant (“PDA”), a mobile phone or other type of computing device. The client device 14 preferably is controlled by a processor 30 that is connected to other components via at least one bus for accomplishing specific tasks. In particular, the client device 14 also includes a volatile memory 32 and a persistent storage 34 for storing information. A display adapter 36 is also provided for transmitting user interface information to a display 38. An input device 40, such as a keyboard, is provided for accepting user input. The server device 16 may be, for example, a network server computer that manages traffic on the network 12 or a web server computer that delivers documents on the World Wide Web (“web pages”). The server device 16 preferably includes a processor 50 connected via at least one bus to a volatile memory 52 and a persistent storage 54. The exemplary hardware configurations shown for the client device 14 and the server device 16 are meant to be illustrative, rather than limiting and those skilled in the art will recognize that other hardware configurations are possible.

The client/server application 24 preferably is an interactive request/response type application running over the Hypertext Transfer Protocol (“HTTP”) protocol. The client/server application 24 uses the reliable messaging system 18 to communicate by sending and receiving messages across the network 12.

The reliable messaging system 18 includes a client module 20 executing on the client 14 and a server module 22 executing on the server 16. The reliable messaging system 18 ensures reliable delivery of messages over the network 12 according to application specified delivery semantics. In particular, the reliable messaging system 18 provides synchronous message delivery for the client/server application 24 using the HTTP protocol. Synchronous message delivery refers to the delivery of messages under a time threshold constraint.

For example, the client/server application 24 includes a client application 26, such as a web browser, that runs on the client 14. The client/server application 24 further includes a server application 28, such as a web server software, that runs on the server 16. The client application 26 provides a user interface through which a user communicates with the server application 28. A user initiates an interaction for completing a task by making a selection in the client application 26. Examples of selections are clicking on Uniform Resource Locator (“URL”) links to get a web page or a button displayed in the browser application to initiate a form submission in HTML. For each selection, the client application 26 interfaces with the client module 20 of the reliable messaging system 18 to send a request message to the server application 28 over the HTTP protocol. Each selection, i.e., request message, leads to a response from the server application 28. Specifically, the server application 28 performs some processing based on the request message and interfaces with the server module 22 of the reliable messaging system to send back a response message to the client application 26.

The selection process continues until the user task is completed. An interaction consists of a request and corresponding response pair between the client 14 and the server 16. An interaction sequence represents the complete set of interactions in order of execution until the user task is accomplished or a failure occurs.

For fault tolerance, the reliable messaging system 18 logs messages during normal failure free operation of the distributed system 10. Each message corresponds to a request or response of an interaction. Messages are logged on a per interaction sequence basis. Logged messages are not discarded until the interaction sequence (user task) completes.

At either the client 14 or server 16, the reliable messaging system 18 logs incoming messages as well as outgoing messages. Specifically, messages received by the reliable messaging system 18 from the network are logged before they are delivered to the either the client application 26 or the server application 28. Messages received by reliable messaging system 18 from either the client application 26 or the server application 28 are logged before they are sent across the network. The reliable messaging system 18 preferably logs messages synchronously, as described above, because synchronous logging offers better reliability guarantees and simplified and faster recovery than asynchronous logging.

In particular, server-side processing of client request messages and message logging works as follows. Every client request message arriving at the server 16 is queued in a communication queue, such as a TCP/IP queue. The client request message is then logged to persistent storage 54 of the server 16, such as a hard disk. After logging, the client request message is put in a server application queue. The server application 28 is multithreaded and processes multiple requests at a time. Each thread in the server application 28 takes a pending request out of the server application queue, processes it and generates a response. The server response is then logged to the persistent storage 54 of the server 16 and sent to the client application 26.

The reliable messaging system 18 can implement multiple message logging schemes having different fault tolerance and performance trade-offs. For example, the reliable messaging system 18 can log messages during failure free system operation on the client 14, or the server 16, or both the client and the server. In addition, the reliable messaging system 18 can be dynamically reconfigured to switch message logging schemes.

The choice of logging scheme, including client-side logging, server-side logging, and both client-side and server-side logging, can have an effect on user perceived performance and actual system performance. A useful measure of user perceived performance is the application response time or the time that a user must wait to receive a response after sending a request. Delays in application response times are significant because users are known to give up on an application if their requests are not met within certain time limits.

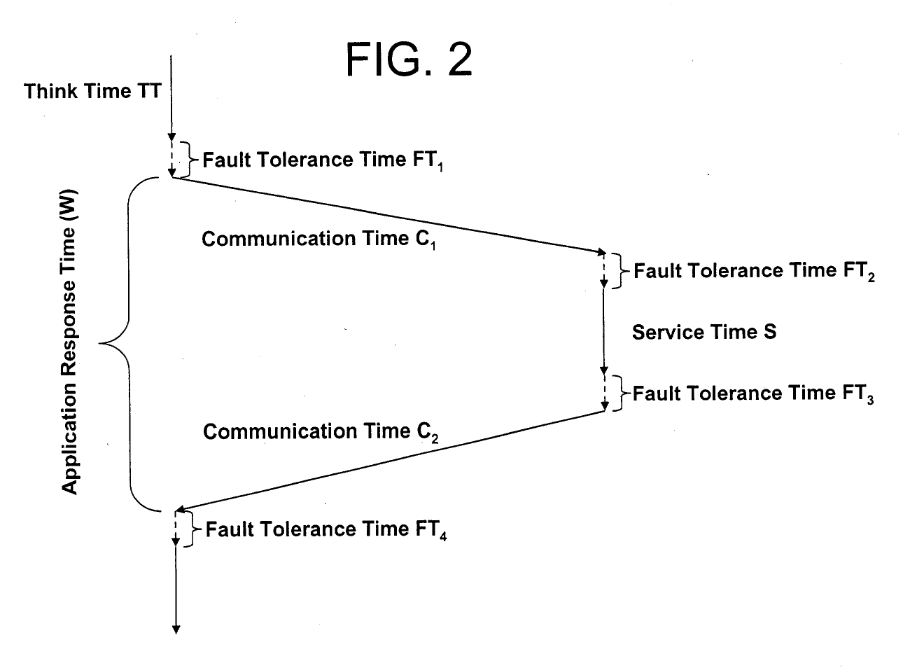

Specifically, a timeline for user interactions with an application is shown in FIG. 2. A user moves through alternate think times (TT) and application response times (W). At the end of each think time (TT), the user initiates an interaction in the client application 26 and waits for a reply. The client application 26 then sends a request to the server application 28, as described above. The server application performs some processing to service the request and sends back a response to the client application. The processing at the server 16 includes a processor bound computation and a set of disk input/output (I/O) operations representing composition and retrieval of a response to be sent back to the client 14. To provide fault tolerance, request messages and response messages may be logged on the client, or the server, or both the client and the server, as described above.

Therefore, the total time that the client application 26 has to wait for a response to arrive is given by:

W=C+S+FT

Where

W is the application response time;

C is the total time spent in communications between the client 14 and server 16 and includes communication times in both directions, C₁ and C₂;

S is the total service time and includes time spent in computation and data I/O at the server 16; and

FT is the total time spent in message logging and includes the total message logging time on the server 16, FT₂ and FT₃, and the total message logging time on the client 14, FT₁ and FT₄.

The total time spent in message logging (FT) depends on the message logging scheme in use, including client-side message logging, server-side message logging, or both client-side and server-side message logging. In particular, FT₁ corresponds to the time spent logging a request on the client 14, FT₂ corresponds to the time spent logging a request on the server 16, FT₃ corresponds to the time spent logging a response on the server 16, and FT₄ corresponds to the time spent logging a response on the client 14. Therefore, the use of different message logging schemes can vary the application response time (W).

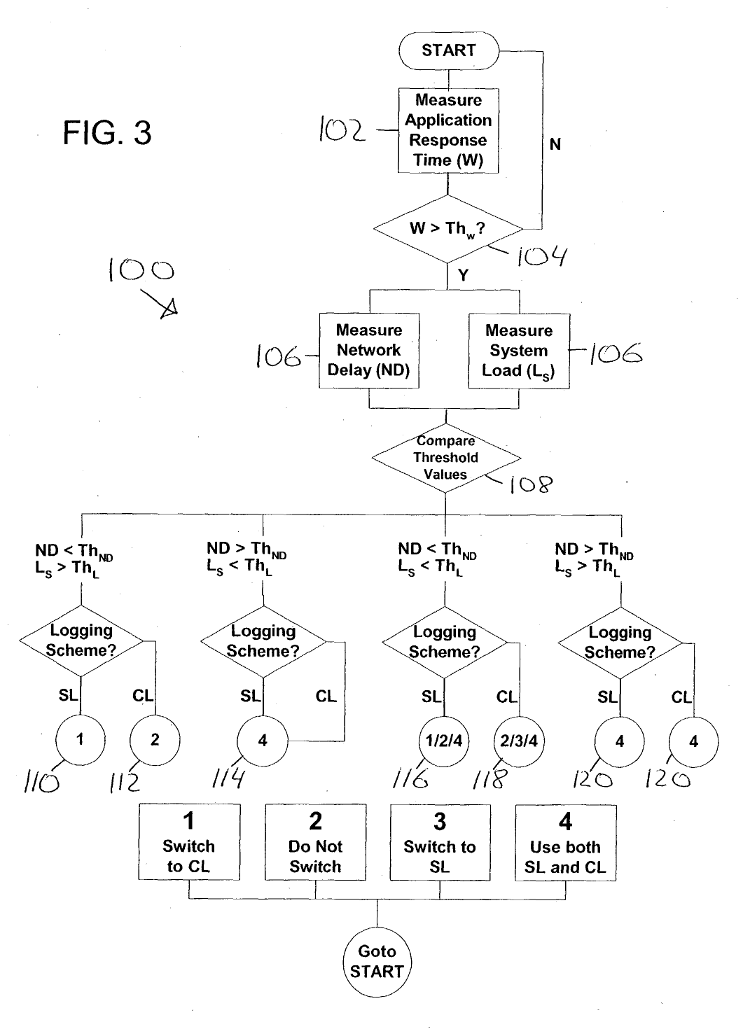

In one embodiment, the present invention is implemented using an algorithm 100 for switching message logging schemes to optimize for the application response time (W) and to improve the user perceived performance of a system, as shown in FIG. 3.

The algorithm 100 is described in the context of the typical distributed system 10 shown in FIG. 1, for which application response times (W) are associated with user requests from the client application 26 to the server application 28. The switching algorithm 100 includes program code or instructions that can be stored in the volatile memory 32 and executed by the processor 30 of the client device 14. Also, the switching algorithm 100 includes program code or instructions that can be stored in the volatile memory 52 and executed by the processor 50 of the server device 164.

The switching algorithm 100 executes continuously on the client 14 and the server 16 in order to switch message logging schemes for the reliable messaging system 18. Therefore, the switching algorithm may switch message logging schemes when the server application 28 is first requested or dynamically during its execution. When the switching algorithm 100 executes simultaneously on the client 14 and the server 16, any conflict between the two devices regarding the desired message logging scheme can be resolved using a handshake protocol. The handshake protocol would allow the client 14 and the server 16 to exchange messages that enable them to agree on the message logging scheme to be used.

In order to optimize the application response time (W), the switching algorithm 100 considers the system load (L_{S}) on the server 16. The system load (L_{S}) in one embodiment corresponds to the number of active client sessions per second at the server 16. An active client session includes all requests from a particular client 14, including requests that are being processed or are pending at the server 16. The system load (L_{S}) is considered because research has shown that the effect of different logging schemes on the application response time (W) may become more significant as the system load increases. Other definitions of system load (L_{S}) may be used.

Also, the switching algorithm 100 considers the end-to-end one-way network delay (ND) between the client 14 and the server 16 in order to optimize the application response time (W). The network delay (ND) in one embodiment corresponds to the time spent in communications between the client and server in either direction (C₁ or C₂). Alternatively, the network delay (ND) can be the average of the time spent in communications between the client and server in both directions (the average of C₁ and C₂). The network delay (ND) is considered because it can serve as an indicator of whether switching message logging schemes will have an appreciable effect on application response times (W) and the user perceived performance of the system. Specifically, a delay in application response times may be caused by a congested network and latency in message delivery rather than the time spent in message logging. For example, if the network delay (ND) is greater than a predetermined application response time threshold (Th_{w}), then switching message logging schemes will likely not improve the user perceived performance because the application response time (W) will remain above the application response time threshold (Th_{w}) regardless of the message logging scheme selected.

Referring to FIG. 3, the switching algorithm 100 obtains the application response time (W) for an application at a first step 102. For example, the client 14 and server 16 in the distributed system of FIG. 1 can use timestamps for actions associated with user interactions in order to measure the application response time (W). Specifically, an HTML based client 14 can intercept all HTTP “GET” and “POST” requests from a web browser type client application 26 to the server application 28. When a “GET” or “POST” request is issued, the client 14 takes a first measurement of the computer clock time or timestamp. When the “GET” or “POST” request returns and the reply generated by the server application is displayed using the browser, a second timestamp is taken by the client 14. The application response time (W) is measured using the difference between the second and first timestamps. The application response time (W) preferably corresponds to a running mean or a variance of a plurality of instantaneous measurements of the difference between the second and first timestamps.

Next, the switching algorithm 100 determines whether the application response time (W) is greater than a predetermined application response time threshold (Th_{w}) at step 104. The application response time threshold (Th_{w}) can be set by the system deployer at startup or dynamically. Several factors may influence the choice of a particular value for the application response time threshold (Th_{w}), including the type of application. Accordingly, an interactive real-time network game may have a smaller Th_{w} value corresponding to a mean application response time, for example about 300 milliseconds, than a database application accessible via a web browsing application, which may have a Th_{w} value of about 1 to 3 seconds.

If the switching algorithm 100 determines that the application response time (W) exceeds the application response time threshold (Th_{w}), then the algorithm obtains values for the system load (L_{S}) and the network delay (ND) at step 106. The number of active client sessions per second at a server corresponding to the system load (L_{S}) can be determined from the number of client requests in the server application queue. Further, those skilled in the art will recognize that the time spent in communications between the client and server in either direction (C₁ or C₂) for determining the network delay (ND) can be measured using timestamps for actions associated with the underlying communication process between the client application 26 and the server application 28.

Next, the switching algorithm 100 compares the system load (L_{S}) with a predetermined system load threshold (Th_{L}) and the network delay (ND) with a predetermined network delay threshold (Th_{ND}) at step 108. The system load threshold (Th_{L}) corresponds to the load (active client session/sec) at which switching from server-side message logging to client-side message logging will reduce the application response time (W) below the application response time threshold (Th_{w}). The value for Th_{L} is system dependant and can be provided by the systems deployer at startup or dynamically. The network delay threshold (Th_{ND}) preferably corresponds to the application response time threshold (Th_{w}) minus the typical service time (S_{T}) for the server 16 to process user requests for the client/server application 24. This allows network specific optimizations that account for variations in network delay. The typical service (S_{T}) preferably corresponds to an average of past service times (S) for the client/server application 24 at the server 16. Alternatively, the network delay threshold (Th_{ND}) may correspond to the application response time threshold (Th_{w}).

The algorithm 100 preferably uses the running mean or variances of the system load (L_{S}) and the network delay (ND) to make the comparison at step 108. The use of mean or variance values rather than instantaneous values for L_{S} and ND prevents the algorithm 100 from thrashing when L_{S} and ND change frequently. Thrashing in this context refers to a state of constantly switching between different logging schemes and has no significant benefit for improving the user perceived performance.

If the system load (L_{S}) is greater than the system load threshold (Th_{L}) and the network delay (ND) is less than the network delay threshold (Th_{ND}), then if the system is performing server-side message logging (SL) the algorithm 100 will switch to client-side message logging (CL) at step 110. Eliminating message logging on the server 16 in this case (i.e., when the server is experiencing a significant load) will result in a considerable improvement in the application response time (W) because the total time spent in message logging (FT) will be substantially reduced. If client-side message logging (CL) is being done, then switching to server-side message logging (SL) will not have any significant effect on the application response time (W) and the algorithm 100 will not switch the client-side logging scheme at step 112.

If the system load (L_{S}) is less than the system load threshold (Th_{L}) and the network delay (ND) is greater than the network delay threshold (Th_{ND}), then it is the network congestion rather than the time spent in message logging (FT) that is having a detrimental impact on the application response time (W). In this case, switching between client-side and server-side message logging is likely to have no significant effect on application response time and the algorithm 100 selects both client-side message logging (CL) and server-side message logging (SL) for improved reliability at step 114.

If the system load (L_{S}) is less than the system load threshold (Th_{L}) and the network delay (ND) is less than the network delay threshold (Th_{ND}), then switching is not going to have any significant impact on application response times. In this case, if server-side message logging (SL) is being done, the algorithm 100 provides the option to switch to client-side message logging (CL) in order to conserve disk space on the server or to continue using server-side message logging (SL) at step 116. Alternatively, if client-side message logging (CL) is being done, the algorithm 100 provides the option to switch to server-side message logging (SL) in order to conserve battery power on the client or to continue using client-side message logging (CL) at step 118. Moreover, the algorithm 100 provides the option to select both client-side message logging (CL) and server-side message logging (SL) to provide faster recovery based on application or user requirements for recovery times at either step 116 or step 118.

If the system load (L_{S}) is greater than the system load threshold (Th_{L}) and the network delay (ND) is greater than the network delay threshold (Th_{ND}), then the algorithm 100 will select both client-side message logging (CL) and server-side message logging (SL) in order to improve reliability at step 120 rather than switch between message logging schemes in an attempt to improve the application response time (W). In this case, increased reliability is preferred because the network delay (ND) exceeds the network delay threshold (Th_{ND}) and the improvement to the application response time (W) may be marginal or insufficiently great to lower W below the application response time threshold (Th_{w}).

All decisions by the algorithm 100 to switch message logging schemes as described above are implemented by the system 10 if there exists sufficient storage overhead at the selected message logging destination for logging messages. The storage overhead on the persistent storage 34 of the client 14 and the persistent storage 54 of the server 16 can be determined using known methods.

In another embodiment of the present invention, the algorithm 100 for switching message logging schemes to optimize for the application response time (W) further considers the effect of the network delay (ND) on the switching overhead latency. The switching overhead latency corresponds to the time required to perform a switch between client-side and server-side message logging schemes. For example, an application 24 may require synchronization of logged messages whenever a switch is made between a client-side message logging scheme and a server-side message logging scheme. In this case, the switching overhead latency includes the one-time delay associated with the transfer of logged messages to the selected message logging destination. If the network delay (ND) is relatively high, then users may find that the impact on application response time (W) caused by the switching overhead latency becomes unacceptable. In this case, the algorithm 100 will not switch message logging schemes if the network delay (ND) is greater than a predetermined switching threshold (Th_{SOL}). The switching threshold (Th_{SOL}) is preferably greater than the network delay threshold (Th_{ND}).

In another embodiment, the algorithm 100 further minimizes the impact of switching message logging schemes on the application response time (W) when a server 16 that communicates with multiple clients 14 is operating at high system loads (L_{S}). In this case, the algorithm 100 will not switch message logging schemes simultaneously for all clients 14, but instead will switch them gradually over time for different client groups.

In another embodiment, the algorithm 100 also makes an initial decision to use a particular logging scheme based on the system load (L_{S}) and the permanent storage space available on the client 14 and the server 16 for logging messages. For example, if the system load (L_{S}) exceeds a predetermined threshold value (Th_{L}), then a client-side logging scheme is selected because the server 16 is already overloaded. However, if the client 14 does not have enough permanent storage space for message logging, i.e., the storage space available on a persistent storage 34 of the client 14 falls below a predetermined threshold value (Th_{storage}), then a server-side message logging scheme is used even though the system load (L_{S}) exceeds the threshold value (Th_{L}).

In another embodiment, the algorithm 100 further uses a smoothing technique to prevent thrashing by limiting the number of allowable switches that can be performed in a given time period. For example, the algorithm 100 may delay or ignore the decision to switch message logging schemes if the number of switches in a given time period exceeds a predetermined smoothing threshold.

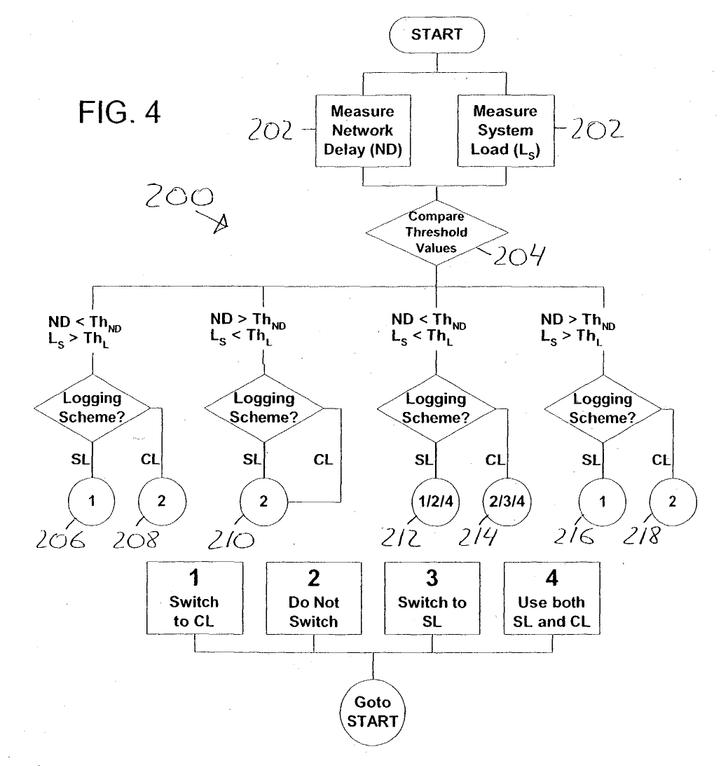

In yet another embodiment, the present invention is implemented using an algorithm 200 for switching message logging schemes to optimize for the server transaction rate and to improve server performance, as shown in FIG. 4. In the context of the distributed system 10 shown in FIG. 1, the server transaction rate corresponds to the number of transactions completed per second at the server 16 of the system 10. The server transaction rate is significant because it represents the processing capacity of a server. In this context, high server transaction rates are desirable by the systems deployer.

In order to optimize for the server transaction rate, the switching algorithm 200 also considers the load on server machine (L_{S}) and the Network Delay (ND) between the client 14 and the server 16.

Referring to FIG. 4, the algorithm 200 first obtains values for the system load (L_{S}) and the network delay (ND) at step 202. Next, the algorithm 200 compares the system load (L_{S}) with a predetermined system load threshold (Th_{L}) and the network delay (ND) with a predetermined network delay threshold (Th_{ND}) at step 204. The system load threshold (Th_{L}) represents the load (active client session/sec) at which switching from server-side message logging to client-side message logging will reduce the application response time (W) below the application response time threshold (Th_{w}). The value for Th_{L} is system dependant and can be provided by the systems deployer. The network delay threshold (Th_{ND}) preferably corresponds to the application response time threshold (Th_{w}) minus the typical service time (S_{T}) for the server 16 to process user requests for the client/server application 24. The typical service (S_{T}) preferably corresponds to an average of past service times (S) for the client/server application 24 at the server 16. The algorithm 200 preferably uses the running mean or variances of L_{S} and ND to make the comparison at step 204 in order to avoid thrashing.

If the system load (L_{S}) is greater than the system load threshold (Th_{L}) and the network delay (ND) is less than the network delay threshold (Th_{ND}), then if the system is performing server-side message logging (SL) the algorithm 200 will switch to client-side message logging (CL) at step 206. This will result in a significant improvement in the server transaction rate. If client-side message logging (CL) is being done, then switching to server-side message logging (SL) will not have any significant effect on the server transaction rate and the algorithm 200 will not switch the client-side logging scheme at step 208.

If the system load (L_{S}) is less than the system load threshold (Th_{L}) and the network delay (ND) is greater than the network delay threshold (Th_{ND}), then switching between client-side and server-side message logging will have no significant effect on the server transaction rate. In this case, the algorithm 200 does not switch message logging schemes at either the client or the server (i.e., the algorithm selects the current logging schemes in use at the client and the server) at step 210. This avoid a potential detrimental impact on the server transaction rate caused by switching overhead latency if switching requires synchronization of logged messages on both the client(s) 14 and the server 16.

If the system load (L_{S}) is less than the system load threshold (Th_{L}) and the network delay (ND) is less than the network delay threshold (Th_{ND}), then switching is not going to have any significant impact on the server transaction rate. In this case, if server-side message logging (SL) is being done, the algorithm 200 provides the option to switch to client-side message logging (CL) in order to conserve disk space on the server or to continue using server-side message logging (SL) at step 212. Alternatively, if client-side message logging (CL) is being done, the algorithm 200 provides the option to switch to server-side message logging (SL) in order to conserve battery power on the client or to continue using client-side message logging (CL) at step 214. Moreover, the algorithm 200 provides the option to select both client-side message logging (CL) and server-side message logging (SL) to provide faster recovery based on application or user requirements for recovery times at either step 212 or step 214.

If the system load (L_{S}) is greater than the system load threshold (Th_{L}) and the network delay (ND) is greater than the network delay threshold (Th_{ND}), then switching can have some positive impact on improving the server transaction rate despite network congestion and switching overhead latency. In this case, the algorithm 200 will switch to client-side message logging (CL) at step 216 if the system is performing server-side message logging (SL). If client-side message logging (CL) is already being done, then switching to server-side message logging (SL) will not have any significant effect on the server transaction rate and the algorithm 200 will not switch the client-side logging scheme at step 218.

Accordingly, the present invention can improve system performance by dynamically switching message logging schemes based on a measure of application response time, system load and network delay. It is important to note that while the present invention has been described in the context of a distributed system, those skilled in the art will recognize that the mechanism of the present invention is capable of being distributed in the form of a computer usable medium of instructions in a variety of forms, and that the present invention applies equally regardless of the particular type of signal bearing media used to actually carry out the distribution. Examples of computer usable mediums include: nonvolatile, hard-coded type media such as read only memories (ROMs) or erasable, electrically programmable read only memories (EEPROMs), recordable type mediums such as floppy disks, hard disk drives and CD-ROMs, and transmission type mediums such as digital and analog communication links.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A method of dynamically switching message logging schemes to improve performance of a distributed system, the distributed system including a client device and a server device that communicate by sending and receiving messages across a network, the client device capable of executing a client-side message logging scheme and the server device capable of executing a server-side message logging scheme, the method comprising:
measuring an application response time for an application that executes using said client device and said server device;
measuring a system load for said server device;
measuring a network delay for said messages;
selecting said client-side message logging scheme when said application response time is greater than an application response time threshold and said system load is greater than a system load threshold and said network delay is less than a network delay threshold;
selecting both said client-side message logging scheme and said server-side message logging scheme when said application response time is greater than said application response time threshold and said system load is less than said system load threshold and said network delay is greater than said network delay threshold;
selecting at least one of said client-side message logging scheme and said server-side message logging scheme when said application response time is greater than said application response time threshold and said system load is less than said system load threshold and said network delay is less than said network delay threshold; and
selecting both said client-side message logging scheme and said server-side message logging scheme when said application response time is greater than said application response time threshold and said system load is greater than said system load threshold and said network delay is greater than said network delay threshold.

2. The method of claim 1 wherein said application response time is measured by one of a running mean and a variance of a plurality of instantaneous values of said application response time.

3. The method of claim 1 wherein said system load is measured by a number of active client sessions per second at said server device.

4. The method of claim 1 wherein said system load is measured by one of a running mean and a variance of a plurality of instantaneous values of said system load.

5. The method of claim 1 wherein said network delay is measured by at least one of a time spent in communication from said client device to said server device and a time spent in communication from said server device to said client device.

6. The method of claim 5 wherein said network delay is measured by an average of said time spent in communication from said client device to said server device and said time spent in communication from said server device to said client device.

7. The method of claim 1 wherein said network delay is measured by one of a running mean and a variance of a plurality of instantaneous values of said network delay.

8. The method of claim 1 further comprising:
measuring a switching overhead latency;
determining whether said switching overhead latency is greater than a switching threshold; and
switching to a selected message logging scheme when said switching overhead latency is greater than a switching threshold;

9. The method of claim 1, wherein said distributed system includes a plurality of groups of client devices connected to said server, further comprising grouping switching to a selected message logging scheme for each of said plurality of groups of client devices gradually.

10. The method of claim 1 further comprising:
providing a smoothing threshold;
switching to a selected message logging scheme only when a number of switches in a given period of time is less than said smoothing threshold.

11. A computer program product embodied on a computer usable medium for dynamically switching message logging schemes to improve performance of a distributed system, the distributed system including a client device and a server device that communicate by sending and receiving messages across a network, the client device capable of executing a client-side message logging scheme and the server device capable of executing a server-side message logging scheme, the computer program product comprising:
instructions for measuring an application response time for an application that executes using said client device and said server device;
instructions for measuring a system load for said server device;
instructions for measuring a network delay for said messages;
instructions for selecting said client-side message logging scheme when said application response time is greater than an application response time threshold and said system load is greater than a system load threshold and said network delay is less than a network delay threshold;
instructions for selecting both said client-side message logging scheme and said server-side message logging scheme when said application response time is greater than said application response time threshold and said system load is less than said system load threshold and said network delay is greater than said network delay threshold;
instructions for selecting at least one of said client-side message logging scheme and said server-side message logging scheme when said application response time is greater than said application response time threshold and said system load is less than said system load threshold and said network delay is less than said network delay threshold; and
instructions for selecting both said client-side message logging scheme and said server-side message logging scheme when said application response time is greater than said application response time threshold and said system load is greater than said system load threshold and said network delay is greater than said network delay threshold.

12. A method of dynamically switching message logging schemes to improve performance of a distributed system, the distributed system including a client device and a server device that communicate by sending and receiving messages across a network, the method comprising:
measuring a system load for said server;
measuring a network delay for said messages; and
selecting at least one of a client-side message logging scheme and a server-side message logging scheme based on whether said system load is greater than a system load threshold and whether said network delay is greater than a network delay threshold.

13. A server device for dynamically switching message logging schemes to improve system performance, the server device capable of communicating with a client device by sending and receiving messages across a network, wherein at least one of said server device and said client device is capable of logging said messages, the server device comprising:
a processor configured to execute program instructions;
a memory connected with said processor, said memory configured to store said programs instructions; and
said program instructions including
a first set of instructions operative to measure a system load for said server,
a second set of instructions operative to measure a network delay for said messages, and
a third set of instructions operative to select at least one of a client-side message logging scheme and a server-side message logging scheme based on whether said system load is greater than a system load threshold and whether said network delay is greater than a network delay threshold.

14. A method of dynamically switching message logging schemes to improve performance of a distributed system, the distributed system including a client device and a server device that communicate by sending and receiving messages across a network, the client device capable of executing a client-side message logging scheme and the server device capable of executing a server-side message logging scheme, the method comprising:
measuring a system load for said server device;
measuring a network delay for said messages;
selecting said client-side message logging scheme when said system load is greater than a system load threshold and said network delay is less than a network delay threshold;
maintaining a current message logging scheme when said system load is less than said system load threshold and said network delay is greater than said network delay threshold;
selecting at least one of said client-side message logging scheme and said server-side message logging scheme when said system load is less than said system load threshold and said network delay is less than said network delay threshold; and
selecting said client-side message logging scheme when said system load is greater than said system load threshold and said network delay is greater than said network delay threshold.

15. The method of claim 14 wherein said system load is measured by a number of active client sessions per second at said server device.

16. The method of claim 14 wherein said system load is measured by one of a running mean and a variance of a plurality of instantaneous values of said system load.

17. The method of claim 14 wherein said network delay is measured by at least one of a time spent in communication from said client device to said server device and a time spent in communication from said server device to said client device.

18. The method of claim 17 wherein said network delay is measured by an average of said time spent in communication from said client device to said server device and said time spent in communication from said server device to said client device.

19. The method of claim 14 wherein said network delay is measured by one of a running mean and a variance of a plurality of instantaneous values of said network delay.

20. The method of claim 14 further comprising:
measuring a switching overhead latency;
determining whether said switching overhead latency is greater than a switching threshold; and
switching to a selected message logging scheme when said switching overhead latency is greater than a switching threshold;

21. The method of claim 14, wherein said distributed system includes a plurality of groups of client devices connected to said server, further comprising grouping switching to a selected message logging scheme for each of said plurality of groups of client devices gradually.

22. The method of claim 14 further comprising:
providing a smoothing threshold;
switching to a selected message logging scheme only when a number of switches in a given period of time is less than said smoothing threshold.

23. A computer program product embodied on a computer usable medium for dynamically switching message logging schemes to improve performance of a distributed system, the distributed system including a client device and a server device that communicate by sending and receiving messages across a network, the client device capable of executing a client-side message logging scheme and the server device capable of executing a server-side message logging scheme, the computer program product comprising:
instructions for measuring a system load for said server device;
instructions for measuring a network delay for said messages;
instructions for selecting said client-side message logging scheme when said system load is greater than a system load threshold and said network delay is less than a network delay threshold;
instructions for maintaining a current message logging scheme when said system load is less than said system load threshold and said network delay is greater than said network delay threshold;
instructions for selecting at least one of said client-side message logging scheme and said server-side message logging scheme when said system load is less than said system load threshold and said network delay is less than said network delay threshold; and
instructions for selecting said client-side message logging scheme when said system load is greater than said system load threshold and said network delay is greater than said network delay threshold.
